(19) United States
(12) Patent Application Publication
(10) Pub. No.: US 2015/0027294 A1
(43) Pub. Date: Jan. 29, 2015

(54) SIMULATED MUSICAL WIND INSTRUMENT

(71) Applicant: Thomas Johnson, Kirkland, WA (US)

(72) Inventor: Thomas Johnson, Kirkland, WA (US)

(21) Appl. No.: 13/950,215

(22) Filed: Jul. 24, 2013

(51) Int. Cl. G10D 9/02

(52) U.S. Cl. CPC G10D 9/02
USPC 84/383 R

(57) ABSTRACT

A simulated musical wind instrument takes the form of a tin whistle or recorder to channel a player's breath toward one or more sensors. In one embodiment, the simulated tin whistle includes a mouthpiece and a stem, and both may be realistically configured. The mouthpiece receives and channels a person's breath towards one or more pressure sensors while the stem includes additional sensors that are selectively touched by a player's fingers to non-audibly generate a musical song, in the simulated musical wind instrument, the mouthpiece may include various openings, sensors and other electronics for generating the non-audible music. Further, the mouthpiece may include a keyed locking member for referencing the mouthpiece when attaching it to the stem.

### FIELD OF THE INVENTION

The present invention generally relates to a simulated musical instrument, and more specifically relates to a simulated, musical wind instrument that takes the form of a tin whistle.

### BACKGROUND OF THE INVENTION

Conventional keyboard, percussion and wind instruments for playing music are widely known. In addition, simulated, electronic versions of keyboard and percussion instruments are also known, for example such as those used in the gaming industry. However, simulated wind instruments are much less common and often vary greatly with respect to the instrument's shape, feel and sound, and most do not replicate closely the actual experience of playing the instrument.

### BRIEF SUMMARY OF THE INVENTION

The present invention is generally directed toward a simulated musical wind instrument that takes the form of a tin whistle or recorder to channel a player's breath toward one or more sensors. In one embodiment, the simulated tin whistle includes a mouthpiece and a stem, and both may be realistically configured. The mouthpiece receives and channels a person's breath (also referred to as wind) towards one or more pressure sensors while the stem includes additional sensors that are selectively touched by a player's fingers to non-audibly generate a musical note. In the simulated musical wind instrument, the mouthpiece may include various openings, sensors, and other electronics for generating the non-audible music. Further, the mouthpiece may include a keyed locking member for referencing the mouthpiece when attaching it to the stern, processes, and structures.

In one aspect of the present invention, a simulated musical wind instrument includes a stem having a plurality of sensors positioned so that a player's fingers can selectively engage the sensors; and a mouthpiece having a fipple section, a stem engagement section and a windway that extends through the fipple section and the stem engagement section, the fipple section having an inlet for receiving the player's breath, the mouthpiece configured with a vent opening sized to regulate air pressure from the breath, the stem engagement section having a pressure sensor configured and located to sample the breath from the windway.

In another aspect of the present invention, a method of simulating a musical wind instrument includes the steps of (1) receiving air into a windway of a mouthpiece, the air initially received into a fipple section of the mouthpiece; (2) compressing the air within the fipple section as the air travels down the windway; (3) regulating the air through a vent located in the fipple section of the mouthpiece, the vent in fluid communication with the windway; (4) sensing the air within a stem engagement section of the instrument, wherein sensing the air includes sampling the air from the windway to periodically measure a static air pressure of the windway; (5) processing data from the measured, static air pressure; and (6) transmitting the processed data to a computing device.

In yet another aspect of the present invention, a mouthpiece for a simulated musical wind instrument includes a fipple section having an inlet for receiving a player's breath and further having a vent opening sized to regulate air pressure from the breath; a stem engagement section; a windway that extends through the fipple section and the stem engagement section; and a pressure sensor in the stem engagement section, the pressure sensor configured to sample the breath from the windway to obtain a static air pressure measurement.

### BRIEF DESCRIPTION OF THE DRAWINGS

Preferred and alternative embodiments of the present invention are described in detail below with reference to the following drawings:

FIG. 1 is a perspective view of a mouthpiece for a simulated musical wind instrument according to an embodiment of the invention;

FIG. 2 is a cross-sectional view of the mouthpiece of FIG. 1 taken along a lengthwise cut through the mouthpiece of FIG. 1 according to an embodiment of the invention;

FIG. 3 is a schematic, top plan view of a simulated tin whistle according to an embodiment of the invention; and

FIG. 4 is a block diagram for a simulated tin whistle according to an embodiment of the invention.

### DETAILED DESCRIPTION OF THE. INVENTION

In the following description, certain specific details are set forth in order to provide a thorough understanding of various embodiments of the invention. However, one skilled in the art will understand that the invention may be practiced without these details. In other instances, well-known structures associated with musical instruments, sensors, processors, and methods of making and playing the same, configuring and/or operating any of the above have not necessarily been shown or described in detail to avoid unnecessarily obscuring descriptions of the embodiments of the invention.

The present invention is generally directed to a simulated, haptic-enabled musical instrument that takes the form of a tin whistle or recorder to channel a player's breath toward one or more sensors. In one embodiment, the simulated tin whistle includes a mouthpiece and a stem, and both may be realistically configured. The mouthpiece receives and channels a person's breath towards one or more pressure sensors while the stem includes additional sensors that are selectively touched by a player's fingers to generate a musical song. In contrast, an actual, conventional tin whistle includes a special shaped mouthpiece that directs the player's breath into the stem, which includes openings that are selectively covered by the player's fingers to create audible music. In the simulated musical instrument, the mouthpiece may include various openings, sensors and other electronics for generating music that may or may not be audible. Further, the mouthpiece may include a keyed locking member for referencing the mouthpiece when attaching it to the stern. In other embodiment, the invention may be directed to other types of wind instruments such as, but not limited to, various types of flutes, horns, harmonicas, etc.

In one embodiment of the present invention, the simulated musical instrument has a similar shape and feel as compared to an actual, conventional tin whistle, yet utilizes an array of sensors and openings to mimic or replicate the sound (audible or non-audible) of the actual, conventional tin whistle. The position and arrangement of the sensors advantageously allows a user to play the simulated tin whistle as if he or she were playing the actual, conventional tin whistle. The simulated tin whistle includes most, if not all, of the physical interfaces commonly found on an actual, conventional tin whistle such as, but not limited to, the stem and the mouthpiece. The components of the simulated tin whistle include mechanical sensors, resistive touch sensors, capacitive touch sensors, pressure sensors and other types of interfaces capable of determining the location of the user's fingers and the dynamic pressure of the user's exhaled breath.

The simulated tin whistle may advantageously help people learn how to play the tin whistle without having to purchase the actual, expensive and fragile instrument. In addition, the simulated tin whistle allows people to practice anytime and anywhere without disturbing others because according to a preferred embodiment of the invention the simulated tin whistle does not make any appreciable, audible sound when being played. The simulated tin whistle may also allow the user to identify and track misplayed notes and pinpoint specific errors such as incomplete fingering or improper breath control.

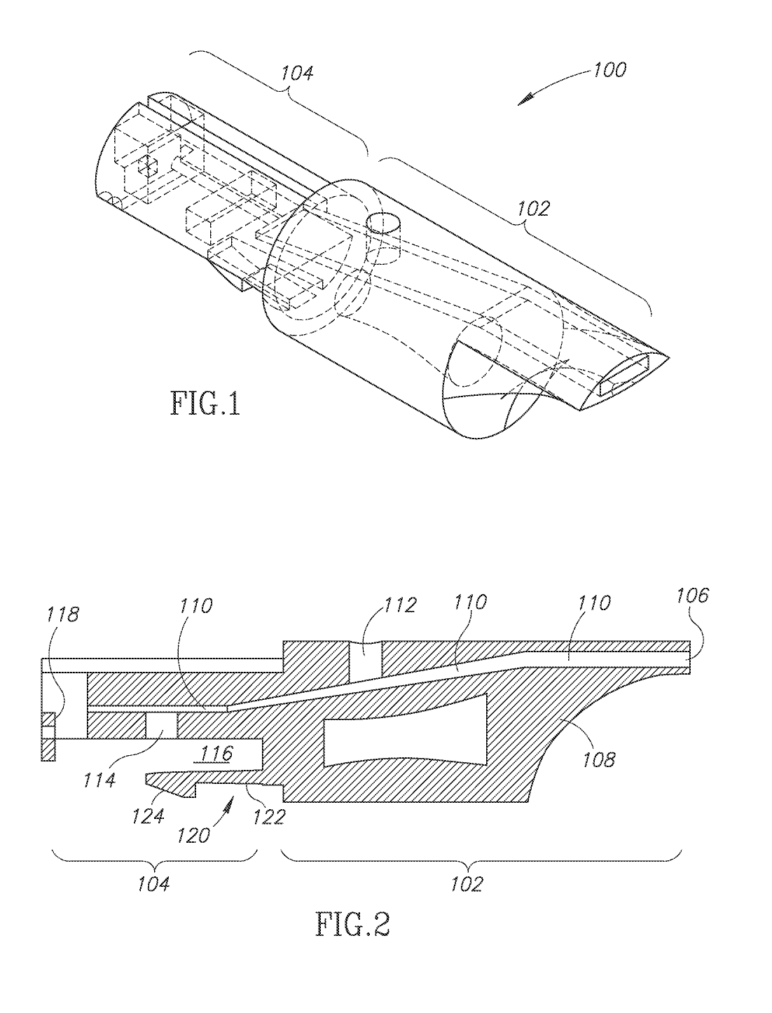

FIGS. 1 and 2 show a mouthpiece 100 for a simulated tin whistle. The mouthpiece 100 includes two sections, a fipple section 102 and a stem engagement section 104. The fipple section 102 includes an inlet 106 for receiving a person's breath. The inlet 106 is located directly above a plug or block 108, which operates to compress the wind as it begins to travel down a windway 110. As the wind continues down the windway 110 and continues to compress because a diameter of the windway narrows when moving from the fipple section 102 to the stem engagement section 104, an amount of moisture may be removed from the wind. through a vent opening 112. Removing such moisture may advantageously prolong the operational life of one or more electronic components located in the stem engagement section 104. Additionally or alternatively, the vent opening 112. is configured to regulate the wind, which may include discharging some amount of the wind to an ambient environment, to better replicate the airflow through an actual, conventional tin whistle. The vent opening 112 may also provide an access port for cleaning the windway 110. In one embodiment, the vent opening 112 is sized to remove moisture, regulate wind pressure, and provide cleaning access for the windway without generating an audible sound from the wind.

The windway 110 extends into the stem engagement section 104 and directs the wind to flow over a pressure sensor 114. In one embodiment, the pressure sensor measures the wind pressure by sampling or “tapping” the wind from the windway 110. Such tapping permits the pressure sensor 114 to measure the static wind pressure relative to a reference pressure. By way of example, the pressure sensor 114 may take the form of a diaphragm type pressure sensor having a flexible membrane that separates the static wind pressure from the reference pressure. The reference side of the diaphragm may be open to the ambient air pressure 116, a second port or cavity to measure differential pressure, or may be sealed against a vacuum or other fixed. reference pressure to measure absolute pressure. The deformation of the diaphragm may be calibrated. The wind pressure may be measured using mechanical, optical, capacitive piezorestive (strain gauges), magnetic, piezoelectric (quartz), and resonant techniques. In the illustrated embodiment in FIG. 2, the pressure sensor 114 is located beneath the windway and within the stem engagement section 104.

In addition to the pressure sensor 114, the stem engagement section 104 may include a power and data connection bracket 118. In one embodiment, the bracket 118 provides supports for the data and power connector if the pressure sensor 114 is located in the mouthpiece 100. In such an embodiment, the mouthpiece 100 includes the pressure sensor 114 and includes the data and power connections necessary to provide the sensor 114 with power and transfer data generated by the sensor 114 to the stem engagement section 104. One purpose of the bracket 118 is to support and orient the electronics, the power supply, the wiring, and the internal structure relative to the other portions of the instrument.

Further in the illustrated embodiment, a locking tab or lever 120 extends from the tipple section 102. The locking tab 120 includes an elongated portion 122 and a tab portion 124. The elongated portion 122 is bendable in a linear elastic manner and the tab portion 12.4 is configured to engage a complementary opening in the stem of the simulated tin whistle. The locking tab 12.0 may advantageously provide a means for referencing the mouthpiece 100 to the stem of the tin whistle such that the mouthpiece is always correctly and/or at least sufficiently oriented with respect to the stem when assembled or reassembled. The locking tab may take a variety of forms such as, but not limited, to having different orientations and fastening means (e.g., mechanical, magnetic, press fit, etc.).

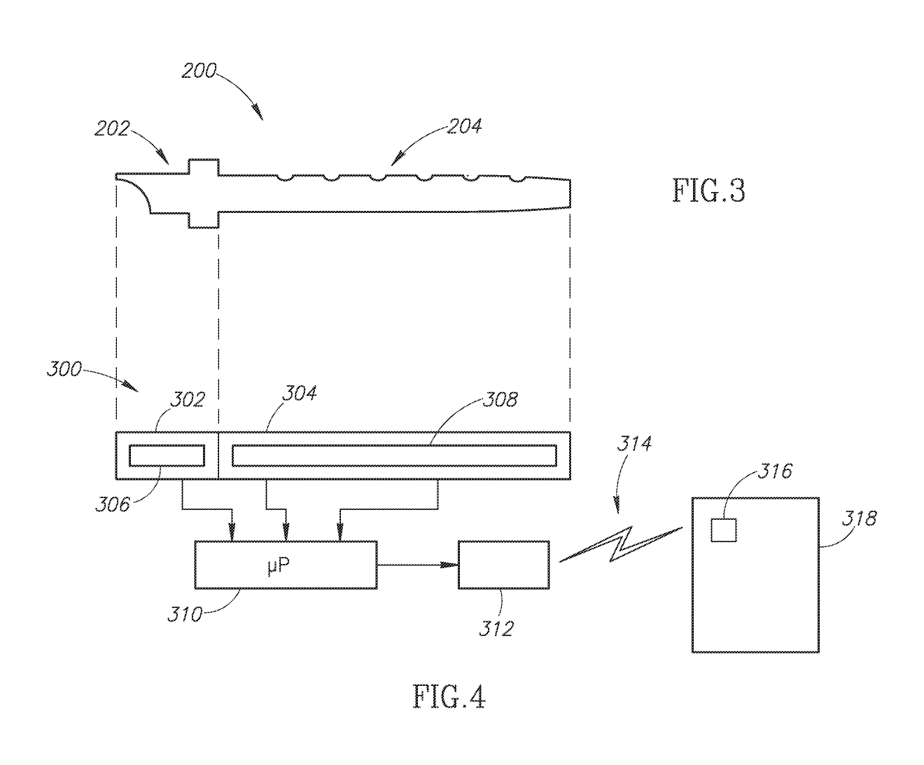

FIG. 3 shows a simulated musical wind instrument 200 that takes the form of a simulated tin whistle according to a preferred embodiment of the present invention. The instrument 200 includes a mouthpiece 202 and a stem 204. The mouthpiece 202 and the stem 204 both include one or more electronic components and/or interfaces that react to a type and a magnitude of an input generated by a user. By way of example, the mouthpiece 202 includes electronic components and/or interfaces that react to a pressure of the user's breath, whereas the stem 204 includes various sensors that react to an amount of finger pressure generated by the user.

FIG. 4 shows a block diagram 300 that corresponds to the simulated tin whistle of FIG. 3. In the illustrated embodiment, the simulated tin whistle includes a mouthpiece section 302 coupled to a stem section 304. The mouthpiece section 302 includes one or more sensors 306 for measuring a static pressure of a tin whistle player's breath as it (i.e., wind) travels down a windway formed in the mouthpiece section 302. The stem section 304 includes one or more sensors or interfaces 308 configured to determine a type and magnitude of the tin whistle player's finger inputs. In the illustrated embodiment, mouthpiece sensors 302 and the stem sensors/interfaces 308 communicate with a microcontroller or microprocessor 310 to process the sensed inputs (e.g., breath pressure and finger pressure).

In one embodiment, the sensed inputs are provided to a radio frequency (RE) transceiver 312, which in turn transmits wireless signals 314 to an application 316 that resides on a smart phone 318 according to the illustrated embodiment. However, the wireless signals 314 may be transferred to a different processing platform such as, but not limited to, a computer or digital pad having a software program or application for reading and interpreting the signals 314. The application 316 converts the signals 314 into audible sounds that resemble musical notes of the simulated tin whistle. The application 316 may also record the interpreted signals so that the audible sounds may be played at a later time. The application 316 may also display the interpreted signals in a musical format or as other graphics as selected by the user. The application 316 may also network with other similar software for coordinated playing of the audible sounds. In one embodiment, the application 316 may overlay other audio files together with the interpreted signals to provide feedback about the user's proficiency in playing the simulated tin whistle. The smart phone 318 or other processing platform may have speakers and/or headphone jacks to provide the audio output.

The simulated wind instrument, such as the simulated tin whistle described herein, may advantageously provide a practice environment that closely simulates playing an actual instrument, at least in part because the simulated wind instrument has approximately the same shape, weight and feel as an actual instrument.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A simulated musical wind instrument comprising:
a stem having a plurality of sensors positioned so that a player's fingers can selectively engage the sensors; and
a mouthpiece having a fipple section, a stern engagement section and a windway that extends through the fipple section and the stem engagement section, the fipple section having an inlet for receiving the player's breath, the mouthpiece configured with a vent opening sized to regulate air pressure from the breath, the stem engagement section having a pressure sensor configured and located to sample the breath from the windway.

2. The simulated musical wind instrument of claim 1, further comprising a locking tab for coupling the mouthpiece to the stem.

3. The simulated musical wind instrument of claim 1, wherein the locking tab operates to reference the mouthpiece with the stern.

4. The simulated musical wind instrument of claim 1, wherein the pressure sensor is a diaphragm pressure sensor.

5. The simulated musical wind instrument of claim 1, wherein the vent opening is further sized to permit access for cleaning the windway.

6. The simulated musical wind instrument of claim 1, wherein the pressure sensor is located beneath the windway.

7. The simulated musical wind instrument of claim 1, further comprising a power and data connection bracket located within the stem engagement section of the mouthpiece.

8. A method of simulating a musical wind instrument, the method comprising:
receiving air into a windway of a mouthpiece, the air initially received into a fipple section of the mouthpiece;
compressing the air within the fipple section as the air travels down the windway;
regulating the air through a vent located in the fipple section of the mouthpiece, the vent in fluid communication with the windway;
sensing the air within a stem engagement section of the instrument, wherein sensing the air includes sampling the air from the windway to periodically measure a static air pressure of the windway;
processing data from the measured, static air pressure; and
transmitting the processed data to a computing device.

9. The method of claim 8, further comprising converting the processed data into audible musical notes.

10. The method of claim 8, wherein compressing the air within the fipple section includes directing the air into a narrower portion of the windway.

11. The method of claim 8, wherein regulating the air through the vent includes discharging some of he air to an ambient environment through the vent.

12. The method of claim 8, wherein processing the data includes processing the data with a processor located within the instrument.

13. The method of claim 8, wherein transmitting the processed data includes transmitting the processed data wirelessly to the computing device.

14. The method of claim 8. wherein receiving air into the windway includes receiving the air without emitting a musically audible sound.

15. A mouthpiece for a simulated musical wind instrument, the mouthpiece comprising:
a fipple section having an inlet for receiving a player's breath and further having a vent opening sized to regulate air pressure from the breath;
a stem engagement section;
a windway that extends through the fipple section and the stem engagement section; and
a pressure sensor in the stem engagement section, the pressure sensor configured to sample the breath from the windway to obtain a static air pressure measurement.

16. The mouthpiece of claim 15, wherein a diameter of the windway narrows as the windway extends from the fipple section to the stem engagement section.

17. The mouthpiece of claim 15, further comprising a locking tab extending from he stem engagement section

18. The mouthpiece of claim 15, wherein the pressure sensor is a diaphragm pressure sensor.
